(19) United States
(12) Patent Application Publication
(10) Pub. No.: US 2016/0188783 A1
(43) Pub. Date: Jun. 30, 2016

(54) COMPUTER-AIDED CARD DESIGN VALIDATION

(71) Applicant: Mastercard Asia/Pacific Pte. Ltd., Singapore (SG)

(72) Inventors: Jiaming Li, Singapore (SG); Donghao Huang, Singapore (SG); Alvin Lee, Singapore (SG); Eric McCreary, Singapore (SG); Andy Low, Singapore (SG)

(21) Appl. No.: 14/977,617

(22) Filed: Dec. 21, 2015

(30) Foreign Application Priority Data
Dec. 26, 2014 (SG) 10201408694W

(51) Int. Cl. G06F 17/50

(52) U.S. Cl. CPC G06F 17/5081

(57) ABSTRACT

A method for computer-aided validation of a card design is disclosed, the method comprising the steps of detecting a plurality of design elements related to a card design via an image recognition device and encoding the design elements into data elements; comparing the data elements against design requirement encoded as design requirement data; validating the card design by determining if each of the data elements are compliant with the design requirement; wherein the comparison of the data elements and the validation of the card design is performed at a processor; and providing a result of the validation via a user interface.

### CROSS-REFERENCE TO RELATED APPLICATIONS

This application claims foreign priority to Singapore Patent Application No. 10201408694W filed on 26 Dec. 2014, the complete disclosure of which is expressly incorporated by reference herein in its entirety for all purposes.

### FIELD OF THE INVENTION

The following discloses arrangements for computer-aided validation of purchase card design.

### BACKGROUND

A purchase card design incorporates many design elements on the card. Examples of design elements include physical dimensions of the card, dimensions and position of trademarks, font and font size of identification details on the card.

These design elements may be required to conform to International Organization for Standardization (ISO)/International Electrotechnical Commission (IEC) standards including 7810, 7811 and 7816 which relate to the standardization of physical characteristics, recording techniques and integrated circuit(s) used in identification cards.

Additionally, the card design incorporating a trademark may be required to conform to the trademark's design requirements. The trademark's design requirements may include the size of the trademark, the colour of the trademark and/or the position of the trade mark on the purchase card for example.

The complexity of the situation is compounded by the fact that a single purchase card design may comprise one or more trademarks on the card, with each trademark having a set of design requirements. Furthermore, a trademark's design requirement may necessitate, or preclude, the presence of another. Accordingly, the validation of a purchase card design is a convoluted task.

Conventionally, the validation of a purchase card design is performed manually. Users may submit a purchase card design for validation, and a staff performing the validation would inspect the purchase card design to ensure that it satisfies the design requirements. The conventional manual validation process has several striking disadvantages. The efficiency of this manual validation process depends highly on the skill and experience of the staff. A new staff would need time to be trained and guided to perform the validation effectively. Moreover, the validation process is time consuming and requires undivided attention from the staff performing the validation, which may not be constant throughout the day. The reliance on human labour, coupled with the complexity of design requirements, may lead to errors during the validation process.

Thus, what is needed is a computer-aided purchase card design validation system that is able to automate the validation process, which is easy to use and robust. Furthermore, other desirable features and characteristics will become apparent from the subsequent detailed description and the appended claims, taken in conjunction with the accompanying drawings and this background of the disclosure.

### SUMMARY

In a first aspect of the present invention, a method for computer-aided validation of a card design is provided, the method comprising the steps of: detecting a plurality of design elements related to a card design via an image recognition device and encoding the design elements into data elements; comparing the data elements against design requirement encoded as design requirement data; validating the card design by determining if each of the data elements are compliant with the design requirement; wherein the comparison of the data elements and the validation of the card design is performed at a processor; and providing a result of the validation via a user interface.

In a second aspect of the present invention, a computer system for computer-aided validation of a card design is provided, the computer system comprising detect a plurality of design elements related to a card design via the image recognition device and encode the design elements into data elements; compare the data elements against design requirement encoded as design requirement data; validate the card design by determining if each of the data elements are compliant with the design requirement; wherein the comparison of the data elements and the validation of the card design is performed at the at least one processor; and provide a result of the validation via the user interface.

In a third aspect of the present invention, a computer readable storage medium is provided, the computer readable storage medium having a computer program recorded therein, the program being executable by a computer apparatus to make the computer apparatus, when performing computer-aided validation of a card design, at least to: detect a plurality of design elements related to a card design via an image recognition device and encode the design elements into data elements; compare the data elements against design requirement encoded as design requirement data; validate the card design by determining if each of the data elements are compliant with the design requirement; wherein the comparison of the data elements and the validation of the card design is performed at a processor; and provide a result of the validation via a user interface.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment, by way of example only.

FIG. 1A illustrates a card design comprising a plurality of design elements related to the card design, and FIG. 1B illustrates a corresponding design requirement for the card design.

FIG. 2 depicts a flowchart of a method embodying computer-aided card design validation in accordance with a present embodiment.

FIG. 3 depicts an exemplary sequence of events when performing the method shown in FIG. 2.

FIG. 4 depicts a block diagram embodying a system for computer-aided validation of a card design.

FIG. 5 depicts a block diagram embodying a network for computer-aided validation of a card design.

FIG. 6 depicts a block diagram embodying a communication device for computer-aided validation of a card design.

FIG. 7 depicts a block diagram embodying computer architecture for computer-aided validation of a card design.

Skilled artisans will appreciate that elements in the figures are illustrated for simplicity and clarity and have not necessarily been depicted to scale. For example, the dimensions of some of the elements in the block diagrams or steps in the flowcharts may be exaggerated in respect to other elements to help improve understanding of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the present embodiment to present an improved computer-aided purchase card design validation system that is automated and easy to use.

Purchase cards may comprise credit cards, membership cards, and payment cards, in physical or digital form. Traditional physical payment cards have a visual layout which both provides an area for branding information from the issuer, and helps people discriminate between multiple cards in their possession. The coloured background and associated logos are easily associated to a particular purchase card, for example the corporate colour used by a bank.

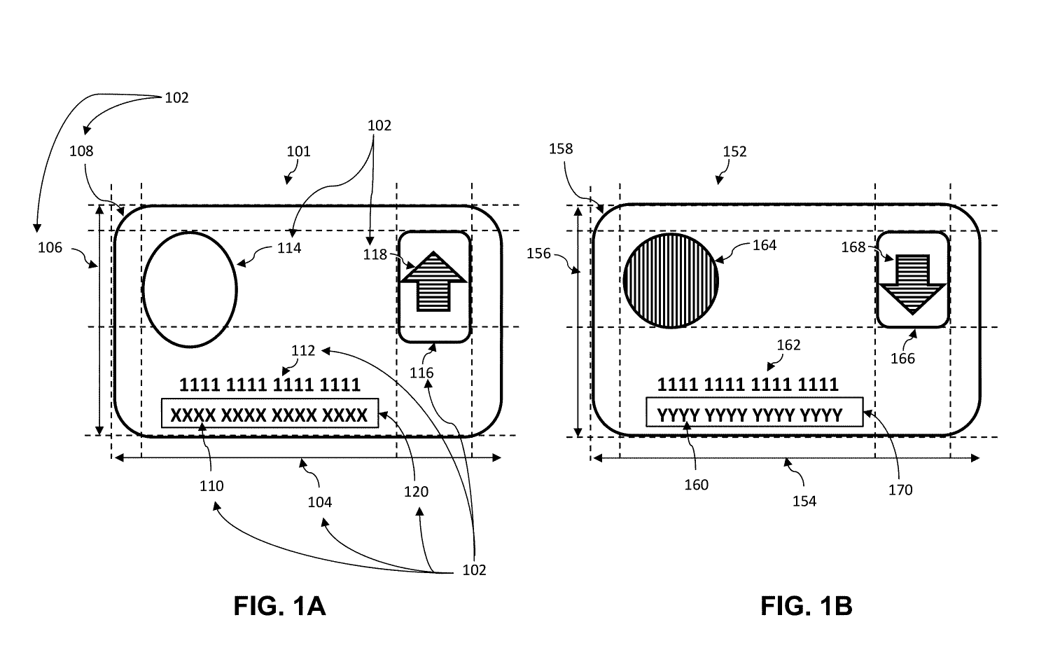

The move to mobile devices for payment has incentivised the use of purchase cards having digital format. Purchase cards are displayed in digital formats across a range of mobile devices having a variety of screen sizes, resolutions, and pixel density. Design requirements exist to ensure that purchase cards in digital format are displayed correctly. For example, card issuers expect that images of such digital purchase cards used as payment means display in the same way across devices, for branding and standardization. In the following detailed description, “card” may refer to physical and/or digital purchase cards. FIG. 1A illustrates a card design 101. The card design 101 refers to a card having a layout for verification whether the layout meets a design requirement, wherein the layout refers to the arrangement of content on both surfaces of the card. FIG. 1A illustrates the card design 101, where such content comprises a plurality of design elements 102 related to the card design 101. Such content is then checked to determine whether each design element 102 complies with a corresponding requirement, where FIG. 1B illustrates the corresponding design requirement 152 for the card design 101.

In an embodiment, the plurality of design elements 102 related to a card design 101 is detected via an image recognition device. The image recognition device comprises any one or more of a hardware based image capturing device (such as a camera) or a software based image recognition application. After being detected, the design elements 102 are encoded into data elements.

In an embodiment, the design requirement 152 is encoded as design requirement data. The data elements are compared against the design requirement data to validate the card design by determining if the data elements are compliant with the design requirement 152. The comparison of the data elements and the validation of the card design 101 is performed at the at least one processor. Finally, a result of the validation is provided via a user interface.

The design elements 102 may comprise any one or more of the card dimensions including length 104, width 106, thickness (not shown), and radius of corners 108 of the card. The design elements 102 may also comprise any one or more of text 110 and numbers 112, which may have a variety of typeface, colour, size, height, contrast, italicisation, spacing, abbreviation, presentation format, and content. The design elements 102 may also comprise any one or more of graphical objects 114, 116, 118, 120, which may have a variety of orientation, positioning, aspect ratio, dimension, opacity, sharpness, presence, and relative distances. The aspect ratio may refer to the ratio between two dimensions of a design element. For example, the aspect ratio of a rectangle is the ratio of its longer side to its shorter side (i.e. the ratio of the length to the width). Relative distances may refer to the distance between any two graphical objects 114, 116, 118, and 120. The design elements 102 may also comprise any one or more colours of the background of the card, graphical objects 114, 116, 118, 120, text 110, and numbers 112, having colour parameters including value, hue, and chroma.

In the present embodiment, the user creating the card design 101 may be required to conform the design elements 102 of the card design 101 to design requirements 152 before the card design 101 is approved. In order for the card design 101 to be approved, the design elements 102 would need to be validated to ascertain that the design elements 102 meet the design requirement 152.

The design requirement 152 may comprise any one or more of the card dimensions including length 154, width 156, thickness (not shown), and radius of corners 158 of the card. In addition, the design requirement 152 may also comprise any one or more of text 160 and number 162 requirements including typeface, colour, size, height, contrast, italicisation, spacing, abbreviation, presentation format, and content. Further, the design requirement 152 may also comprise any one or more of graphical object requirements 164, 166, 168, 170, including orientation, positioning, aspect ratio, dimension, opacity, sharpness, presence, and relative distances. Additionally, the design requirement 152 may also comprise any one or more of colour parameter requirements including value, hue, and chroma. Preferably, the design requirement 152 may also comprise any one or more of design layouts including International Organization for Standardization (ISO)/International Electrotechnical Commission (IEC) 7810, ISO/IEC 7811, ISO/IEC 7816, and/or card design guidelines.

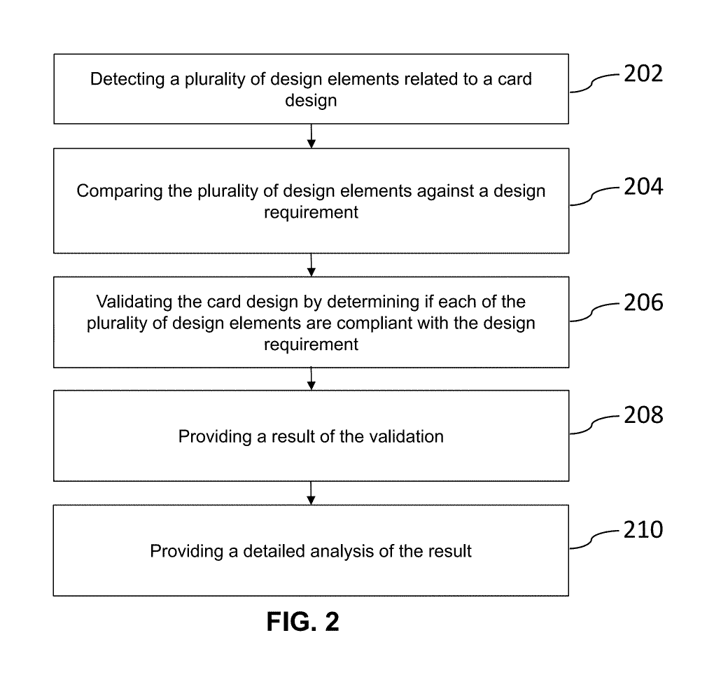

In an embodiment, the design elements 102 may also comprise any one or more proprietary designs such as a logo, brand mark, trade mark, or acceptance mark that are related to the card design 101. For example, if the card design 101 is for a bank, a proprietary designs would be the name of the bank; and slogans or corporate logos that the bank uses. The proprietary design elements have to comply with corresponding design requirements 152. In other words, there is validation performed to determine whether the design elements 102 that are recognised to be proprietary to the card design 101 are in compliance with the design requirement 152 of the proprietary design element. In an embodiment, at least one of the data elements that are proprietary to the card design 101 are recognised. The recognised ones of the data elements are then processed to determine whether the ones of the data elements are in compliance with the design requirement of the proprietary design element 101. FIG. 2 depicts a flowchart of a method embodying computer-aided validation of a card design in accordance with a present embodiment. At step 202, a plurality of design elements 102 related to a card design 101 are detected. At step 204, the plurality of design elements 102 are compared against a design requirement 152. At step 206, the card design 101 is validated by determining if each of the plurality of design elements 102 is compliant with the design requirement 152. At step 208, a result of the validation is provided. In an embodiment, the result of the validation, provided via the user interface, is an indication of a degree of compliance that a data element has with the design requirement. In the embodiment of FIG. 1, the card design 101 would be rejected as a result of the validation conducted by the method shown in FIG. 2, as several design elements 110, 114, 116, 118 are non-compliant with the design requirement 152, namely 160, 164, 166 and 168. In an embodiment, after the result of the validation is provided to the user in step 208, a detailed analysis of the result is provided to the user in step 210. Step 210 is optional, wherein the detailed analysis may comprise information on the extent to which the design elements are compliant or non-compliant with the design requirement. The analysis may provide the degree of compliance, or a list of the design elements 110, 114, 116, 118 of the submitted card design 101 that are non-compliant; guidelines on how the non-compliant design elements may be corrected; or suggestions to arrange the design elements 110, 114, 116, 118 for full compliance. Fully compliant design elements 110, 114, 116, 118 would lead to such design elements 110, 114, 116, 118, being accepted. On the other hand, non-compliant design elements 110, 114, 116, 118 would lead to such design elements 110, 114, 116, 118 not being accepted. Partially compliant design elements 110, 114, 116, 118 would lead to the design elements 110, 114, 116, 118 being accepted or not being accepted based on other factors further elaborated below. Computer-aided validation of the card designs 101 advantageously removes the dependency on manual labor, therefore reducing the likelihood of human error. Additionally, computer-aided validation advantageously allows complex card designs 101 to be validated quickly, without the need to manually inspect each of the plurality of design elements 102, thus increasing the throughput of the validation process.

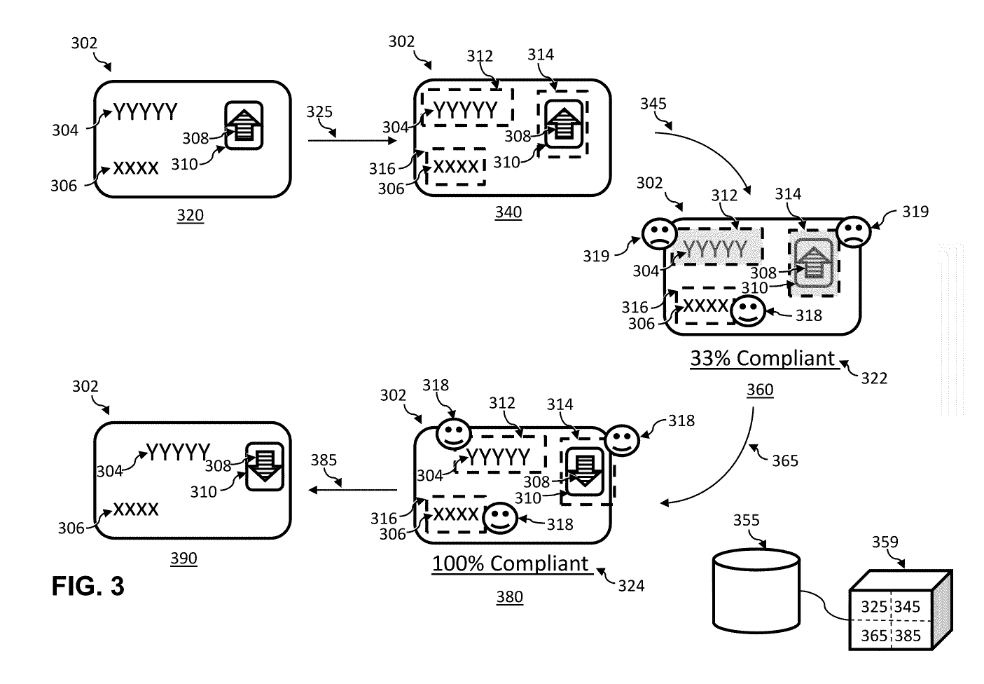

FIG. 3 depicts an exemplary sequence of events when performing the method shown in FIG. 2. In step 320, the user creates a card design 302 to be validated. The card design 302 may be completed in a computer terminal by the user in a graphical format such as JPEG, JPG, PNG, PDF, BMP or TIFF. Alternatively, the card design 302 may be first hand drawn and then input (e.g. electronically scanned or through uploading a taken picture), which is uploaded into the computer terminal used to submit the card design 302, The card design 302 comprises a plurality of design elements 304, 306, 308, 310 that the user has incorporated into the card design 302. In the example shown in FIG. 3, the design element 304 is a string of text, the design element 306 is a second string of text, the design element 308 is a symbol with an orientation and the design element 310 is a shape with a certain dimension encompassing the symbol. In an implementation where a computing device (such as a server), which has been configured to operate the method described above in FIG. 2, is external to the computer terminal used to create the card design 302, the completed card design 302 is then submitted to this computing device for validation.

The submitted card design 302 is processed using an automated image recognition method, represented using reference numeral 325. Properties of the design elements 304, 306, 308, 310 such as the identity, position, orientation and size of the design elements 304, 306, 308, 310 are detected by the automated image recognition method 325. The type of automated image recognition method 325 used to detect the design elements 304, 306, 308, 310 may vary depending on the type of design elements 304, 306, 308, 310 present in the submitted card design 302. In an embodiment, design elements 304, 306 comprising text or numbers may be identified by using an automated image recognition method 325 such as optical character recognition (OCR) algorithms including Stroke Width Transform. In an embodiment, design elements 308, 310 comprising a rigid image patch (e.g. a logo or icon) may be identified by using an automated image recognition method 325 such as template matching. In an embodiment, if samples images or templates of design requirements are available, the automated system may be trained to recognize the design elements 304, 306, 308, 310 in the submitted card design 302.

In an embodiment, training of the automated image recognition method 325 may be based on feature classification algorithms such as Support Vector Machine (SVM) or Convolutional Neural Network (CNN). Training an automated image recognition method 325 based on SVM or CNN generally involves providing a training data set comprising design requirements, design templates, and design rules. Using the training data set, the SVM or CNN is able to compare the design elements 304, 306, 308, 310 of the submitted card design 302 with the training data set.

In an embodiment, an automated image recognition method 325 may detect design elements 304, 306, 308, 310 in two steps. The first step utilizes the automated image recognition method 325 to detect and identify the design elements 304, 306, 308, 310 from the submitted card design 302. A second step utilizes design requirements, such as design rules and guidelines, to guide the automated image recognition method 325 to identify and detect the design elements 304, 306, 308, 310.

In step 340, the automated image recognition method 325 may provide an indication, via a user interface, 312, 314, 316 to locate or identify the design elements 304, 306, 308, 310 to the user or the staff validating the card design 302. For example, design element 304 may be identified as a string of text that is located in the left hand corner of the card design 302, the string of text indicating the name of a bank that will be issuing the card design 302. Currently, this process is performed manually by the staff validating the card design 302. Implementation of the automated image recognition method 325 advantageously reduces the dependence on manual analysis of the card design 302. In addition, the use of automated image recognition method 325 advantageously improves the accuracy of the identification of the card design elements 304, 306, 308, 310.

In step 360, the design elements 304, 306, 308, 310 of the card design 302 is validated by performing a computer-aided rule based validation, represented using reference numeral method 345. The rule based validation method 345 compares the properties of the design elements 304, 306, 308, 310 of the card design 302 to a set of design requirements (not shown in FIG. 3, but confer design requirement 152 shown in FIG. 1B) related to the card design 302 that are retrieved from a design requirement database 355. In an embodiment, a processor may be configured to retrieve a set of design requirement data (i.e. encoded design elements 304, 306, 308, 310) related to the card design 302 from a database. The processor is further configured to compare the data elements (i.e. encoded design elements) with the retrieved set of design requirement data. The rule based validation method 345 provides a result of the validation, in the form of an indication 318, 319 if a design element is compliant 318 or non-compliant 319 with the design requirement. In an embodiment, the indication 318, 319 may indicate that the design element is partially compliant with the design requirement (not shown). In step 360, the design element 306 is indicated as compliant 318, while the design elements 304, 308, 310 are indicated as non-compliant 319. In the example of FIG. 3, a graphical element (of a smiling or frowning face) is used to direct attention to the compliant 318 or non-compliant 319 design elements 304, 306, 308, 310. The indication may also be accompanied with, or alternatively implemented by, a message providing details of the compliance 318, partial compliance (not shown), or non-compliance 319 and the acceptability to the design requirement. The indication of compliant 318, partially compliant (not shown) or non-compliant 319 design elements 304, 306, 308, 310 serves to notify the user and the staff performing the validation of the card design 302. This advantageously makes the result unambiguous to both the user and the staff performing the validation as to which design elements 304, 306, 308, 310 are compliant 318, partially compliant (not shown), or non-compliant 319. By doing so, potential disputes between the user and the staff performing the validation may be reduced, and the process of validating the card design 302 can be expedited. Furthermore, the staff performing the validation of the card design 302 would be able to devote less time and attention to seek out the compliant 318, partially compliant (not shown), or non-compliant 319 design elements 304, 306, 308, 310, thus advantageously enabling the staff to process more submitted card designs 302 in a shorter period of time.

The acceptability of the design element 304, 306, 308, 310, and corresponding card design 101, is derived from the degree of compliance to the design requirement. In an embodiment, the degree of compliance of a design element 304, 306, 308, 310 may be evaluated to determine the acceptability of the design element 304, 306, 308, 310. For example, a design requirement may set dimension values on a design element 308 (e.g. a logo), along with an associated degree of compliance. The following embodiments consider the scenario where the dimension values are 10 millimeters (mm) in length and 10 mm in width.

One embodiment may have an absolute design requirement. An absolute requirement dictates that the design element 308 has to be sized 10 mm in length and 10 mm in width exactly. Any deviation from this absolute requirement results in design element 308 being assessed as “non-compliant”. If the design element 308 does not meet this absolute design requirement, the design element 308 is not accepted (automatically rejected) and not referred to the staff for further review.

In alternative embodiments, the acceptance of the design element 308 is based on a flexible design requirement. For example, a design requirement having a flexible requirement allows design element 308, to be sized 10 mm in length and 10 mm in width, with an allowance (i.e. tolerance) of ±2 mm. In this case, if the design element 308 is 11 mm in length and 11 mm in width, the dimensions of the design element 308 falls within the allowance of ±2 mm, which results in the design element 308 being assessed as “partially compliant” or “non-complaint within tolerance”. The “partially compliant” or “non-complaint within tolerance” design element 308 would still be accepted. Submitted card designs 302 having any one or more design elements 304, 306, 308, 310 assessed as “partially compliant” or “non-complaint within tolerance” will be flagged for manual review.

If a design element 308 is 15 mm in length and 15 mm in width (i.e. outside the allowance of ±2 mm), the design element is assessed as non-compliant. Submitted card designs 302 having non-compliant design elements are automatically rejected and not referred to the staff for further review. If design elements 304, 306, 308, 310 are assessed to be “partially compliant”, it is still possible for the design elements 304, 306, 308, 310 to be accepted if it has been predetermined that strict compliance to the corresponding design requirements are non-mandatory. In this case, the corresponding design requirements are termed as “non-mandatory design requirements”. In an embodiment, the spacing between lines of design element 308 has a non-mandatory design requirement (not shown) of at least 2 mm. Accordingly, if the spacing between the lines of design element 308 is, less than 2 mm, the design element 308 is assessed as “partially compliant”. However, the partially compliant design element 308 would still be accepted as the corresponding design requirement has been predetermined as a “non-mandatory design requirement”. In the present embodiment, the result of the validation of the card design 302 is a percentage score, which is reduced if any one or more of the “non-mandatory design requirements” are not complied with. Any one or more design element 308 that are assessed to be “partially compliant” due to a breach of the corresponding “non-mandatory design requirement” would lower the percentage score. If the percentage score falls below a certain threshold (e.g. 50%), the submitted card design 302 may be flagged for a manual review or rejected.

In the present embodiment, the result further comprises a score 322 calculated from the number of design elements 304, 306, 308, 310 that are compliant 318 with the design requirements (not shown in FIG. 3, but confer design requirement 152 shown in FIG. 1B). The score 322, advantageously provides a clear and unambiguous message for the user and the staff to evaluate the submitted card design 302. This is beneficial for the process of card design validation as it removes human bias and human error in the process. The score 322 may be a weighted score, weighted based on the importance of each design element 304, 306, 308, 310 and the corresponding design requirement (not shown in FIG. 3, but confer design requirement 152 shown in FIG. 1B) in relation to the standards or guidelines in force. A minimum score 322 of 80%, for example, may be set as the condition for the submitted card design 302 to be approved. This score 322, for example, may indicate that there exists several design elements 304, 306, 308, 310 that are non-compliant 319, however, the degree of non-compliance is mild and may still be accepted. The score 322 therefore provides a unique and advantageous alternative of quantifying the extent of compliance of the submitted card design 302. In an embodiment, the result, provided via the user interface, comprises a score calculated from the number of data elements that are compliant with the design requirements.

In the present embodiment, the result may further comprise one or more suggestions, provided via a user interface, to optimize properties of both compliant 318 and non-compliant 319 design elements 304, 306, 308, 310 to guide the user on how the design elements 304, 306, 308, 310 may be adjusted to ensure that the design elements 304, 306, 308, 310 are compliant with the design requirements (not shown). This is advantageous over the manual card validation process, as there is currently no avenue for the staff performing the validation of the submitted card design 302 to provide immediate feedback to the user on how the design elements 304, 306, 308, 310 may be adjusted to meet the design requirements (not shown). By incorporating a suggestion to adjust the non-compliant 319 design elements 304, 308, 310 to comply with the design requirements (not shown), this advantageously allows the user to adjust the design elements 304, 306, 308, 310 to comply with the design requirements (not shown) before the card design 302 is sent to the staff for approval, thus reducing the time taken for validation.

In the present embodiment, in step 380, the non-compliant 319 design elements 304, 308, 310 are adjusted to achieve full compliance with the design requirement (not shown in FIG. 3, but confer design requirement 152 shown in FIG. 1B). The adjustment 365 may be performed manually by the user that submitted the card design 302 or the staff validating the card design. Alternatively, the adjustment 365 may be performed automatically. In the present embodiment, the position of design element 304, the position and orientation of design elements 308 and 310 had been adjusted to comply with the design requirements (not shown in FIG. 3, but confer design requirement 152 shown in FIG. 1B). The graphical indication 319 on the previously non-compliant design elements 304, 308 and 310 have now changed to a graphical indication 318 that denotes that the modified properties of the design elements 304, 308 and 310 are now compliant 318 with the design requirements (not shown). Additionally, the score 322 is recalculated to a new score 324 representing the validation result. Finally, in step 390, the validated card design 302 that is fully compliant with the design requirement is presented (represented using reference numeral 385) to the user or staff for confirmation. In an embodiment, the adjustment 365 may be performed automatically as a default setting. An option may be provided to the user to opt-out of the default setting, allowing manual manipulation of the design elements.

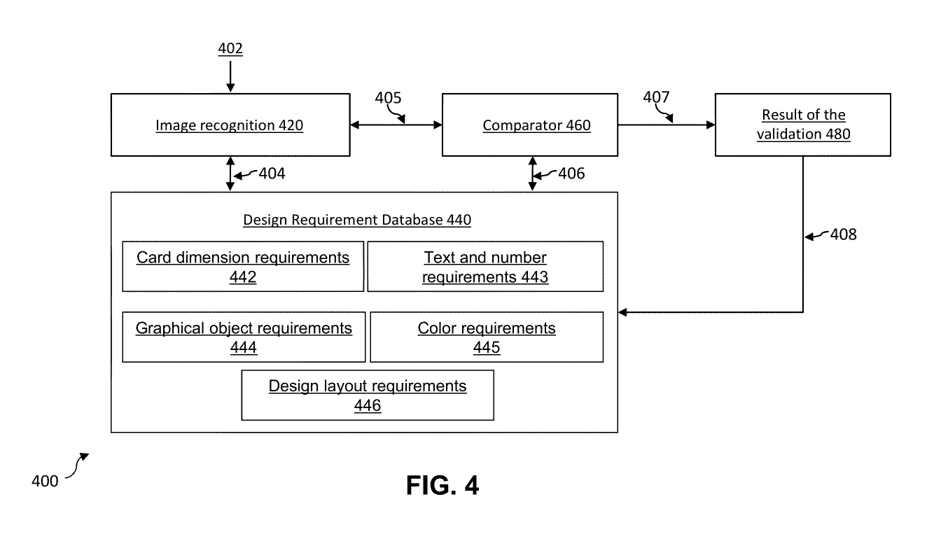

FIG. 4 depicts a block diagram embodying a system 400 for computer-aided validation of a card design in accordance with the present embodiment. A card design is submitted as input 402 to the system 400. The submitted card design 402 is analyzed by an image recognition component 420 using an automated image recognition method to detect a plurality of design elements related to the submitted card design 402. In an embodiment, the design elements related to the submitted card design 402 are detected via an image recognition device, including a hardware image capturing device and a software image recognition device, and encoded into data elements for comparison. The image recognition component 420, using an automated image recognition method, may query 404 a design requirement database 440 to retrieve information related to the submitted card design 402 to provide information to the image recognition component 420. In the present embodiment, all design elements may be identified by the image recognition component 420 using an automated image recognition method. Alternatively, some design elements may be identified using a separate rule-based identification method (not shown). Words or text on the card may be identified by OCR algorithms like stroke width transform, or CNN. Machine Learning Algorithms like CNN and SVM will also help to recognize other known visual elements (e.g. logo, chip). In the present embodiment, during the identification and validation phase, human intervention may be involved to improve the image recognition method 420. Results from human feedback will advantageously improve the engine efficiency and accuracy of the image recognition method 420.

After the plurality of design elements related to the submitted card design 402 are detected, the information is processed 405 by a comparator 460 using a rule based validation method. In an embodiment, the visual features such as color, saturation, logo, dimension ration, for example, are extracted from the design elements. The comparator 460 using a rule based validation method may retrieve 406 a set of design requirements related to the submitted card design 402 from a design requirement database 440. The design requirement database 440 may comprise card dimension requirements 442, text and number requirements 443, graphical object requirements 444, color requirements 445 and design layout requirements 446. The visual features extracted from design elements related to the submitted card design 402 are compared with the set of design requirements retrieved from the design requirement database 440 by the comparator 460 using a rule based validation method. In an embodiment, the data elements are compared against design requirement encoded as design requirement data and validated by determining if each of the data elements are compliant with the design requirement. The comparison of the data elements and the validation of the card design is performed at the processor.

A result of validation 480 is provided 407 via a user interface to the user or the staff performing the validation. In the present embodiment, the result of the validation 480 may be deposited 408 in the design requirement database 440 to improve the design requirement database 440. The result of the validation 480, provided via the user interface, may be an indication that a design element of the submitted card design 402 is compliant or non-compliant with the card design requirements 442. The indication may comprise a message providing details of the compliance, non-compliance, or partial compliance. Alternatively or additionally, the indication, provided via a user interface, may comprise a graphical element directing attention to the compliant or non-compliant design element of the submitted card design 402. In an embodiment, step 408 is a feedback mechanism for the user to provide adjustments to the computer-aided validation method. Human intervention is necessary to improve the accuracy of the computer-aided validation method for unique submitted card designs which the computer-aided validation method has not experienced. In some embodiments, human intervention may occur at the image recognition 420 or at the comparator 460, or during any of the process steps 404, 405, 406 and 407. In the present embodiment, the design requirement database 440 may provide ranking of users that submits card designs. A report may be generated for the user or the staff performing the validation reflecting the number of submitted card designs 402 and the corresponding design elements that were found to be compliant or non-compliant. Advantageously, the result of the validation may be a comparison output for the staff performing validation to review, prior to final approval or rejection.

Further, the indication, provided via the user interface, comprises a message providing details of the degree of compliance and acceptability to the design requirement; and/or wherein the indication, provided via the user interface, comprises a graphical element directing attention to a compliant or non-compliant design element.

In the present embodiment, the user may submit the card design 402 electronically in a standard format readable by the system. In an embodiment, the digital data of the submitted card design 402 comprises image file formats, including one or more of Raw Image Format, Tagged Image File Format and Bitmap Format. The digital data of the submitted card design may also comprise metafile formats, including one or more of PDF, Post Script and PCL. Advantageously, the card design background is preferably submitted together with the card design, in order to improve the accuracy of the visual element recognition. Additionally, the user may also be required to provide information related to the submitted card design 402, including one or more of Business Identification Number and product code.

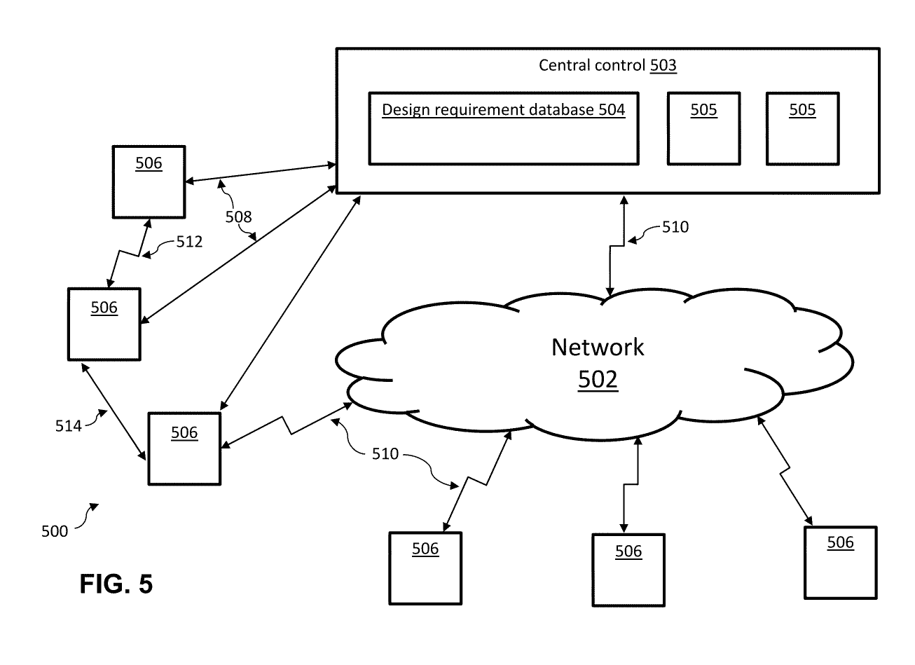

FIG. 5 depicts a block diagram embodying a network 502 for computer-aided validation of a card design in accordance with the present embodiment. A central control 503 comprising a design requirement database 504 and staff access terminals 505 are coupled to the network 502 via a wireless coupling 510. A plurality of user terminals 506 are coupled to the network 502 via a wireless 510 coupling. Users submitting their card designs to be validated by the staff may transmit the card designs from the user terminals 506 through the network 502 to the central control 503 to be validated. The users may also transmit the card designs from the user terminal 506 to the central control 503 via a wired coupling 508. Additionally, users may also transmit card designs directly between user terminals via a wireless 512 or wired 514 coupling, or through the network 502.

The network in 502 provides an efficient and advantageous means for the users submitting card designs to communicate with staff performing the card design validation, and to collaborate with other users within the network 502. Staff performing validation may provide consolidated results of the validation through the network to each of the users within the network, enabling the users to receive up-to-date information on the status of the validation. Advantageously, the staff performing the validation may notify all users across the network 502 of any changes in the design requirements. In this manner, the card design requirements may be transmitted to each of the users efficiently, advantageously improving on the compliance of each card design submitted.

In the present embodiment, the method steps of detecting a plurality of design elements related to a card design, comparing the plurality of design elements against a design requirement, validating the card design by determining if each of the plurality of design elements are compliant with the design requirement, and providing a result of the validation may be performed at the central control 503.

Advantageously, the method steps may be performed at the user terminal 506. This would allow the user to have an immediate result of the validation of the submitted card design, and therefore reducing the time taken for the validation of the submitted card design. In the present embodiment, the role of the staff performing the validation is reduced as the method steps are automated. Manpower dependency in this embodiment is greatly reduced throughout the validation process.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. A method or algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “detecting”, “comparing”, “validating”, “providing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods mentioned above. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below. In addition, the present specification also implicitly discloses a computer program, in that it would be apparent to the person skilled in the art that the individual steps of the method described above may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium. The computer program when loaded and executed on such a computer effectively results in an apparatus that implements the steps of the preferred method.

Various embodiments of the invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

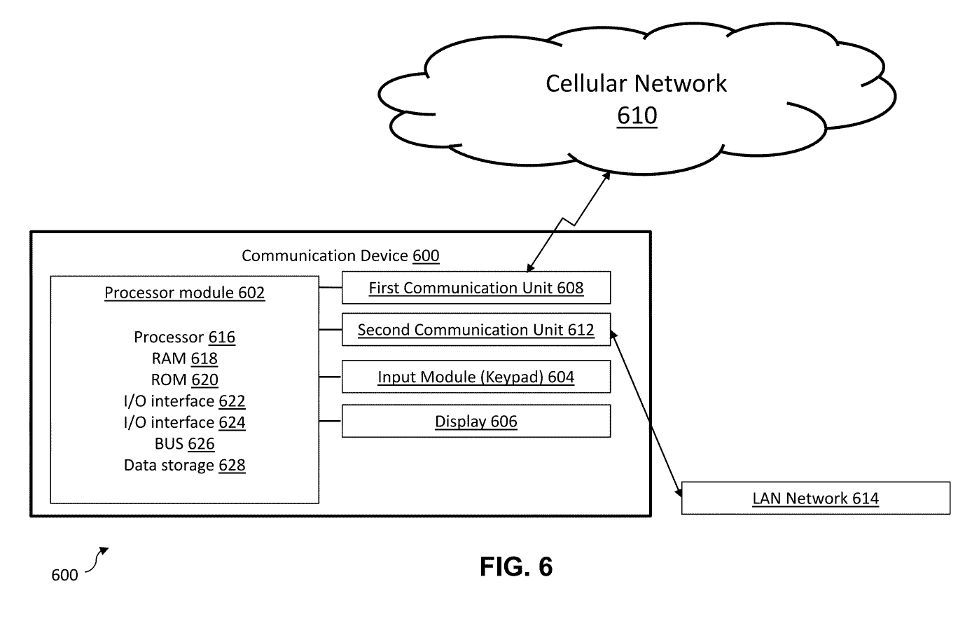

For instance, the method steps 200 of FIG. 2 can be implemented on a communication device 600, as shown in FIG. 6. It may be implemented as software, such as a computer program being executed within the communication device 600, and instructing the communication device 600 to conduct a method of the example embodiment.

The communication device 600 comprises a processor module 602, an input module such as a keypad 604 and an output module such as a display 606.

The processor module 602 is coupled to a first communication unit 608 for communication with a cellular network 610. The first communication unit 608 can comprise, but is not limited to comprising, a subscriber identity module (SIM) card loading bay. The cellular network 610 can, for example, be a 3G network.

The processor module 602 is further coupled to a second communication unit 612 for connection to a local area network 614. For example, the connection can enable wired/wireless communication and/or access to e.g. the Internet or other network systems such as Local Area Network (LAN), Wireless Personal Area Network (WPAN) or Wide Area Network (WAN). The second communication unit 612 can include but is not limited to a wireless network card or an Ethernet network cable port.

The processor module 602 in the example includes a processor 616, a Random Access Memory (RAM) 618 and a Read Only Memory (ROM) 620. The processor module 602 also includes a number of Input/Output (I/O) interfaces, for example I/O interface 622 to the display 606, and I/O interface 624 to the keypad 604.

The components of the processor module 602 typically communicate via an interconnected bus 626 and in a manner known to the person skilled in the relevant art.

An application, which facilitates the card design validation according to the various embodiments mentioned above, is typically supplied to the user of the communication device 600 encoded on a data storage medium such as a flash memory module, memory card/stick or even downloaded from a server, and read utilizing a corresponding memory reader-writer of a data storage device 628 for installation. The installed application is then controlled in its execution by the processor 616. Intermediate storage of program data may be accomplished using RAM 618.

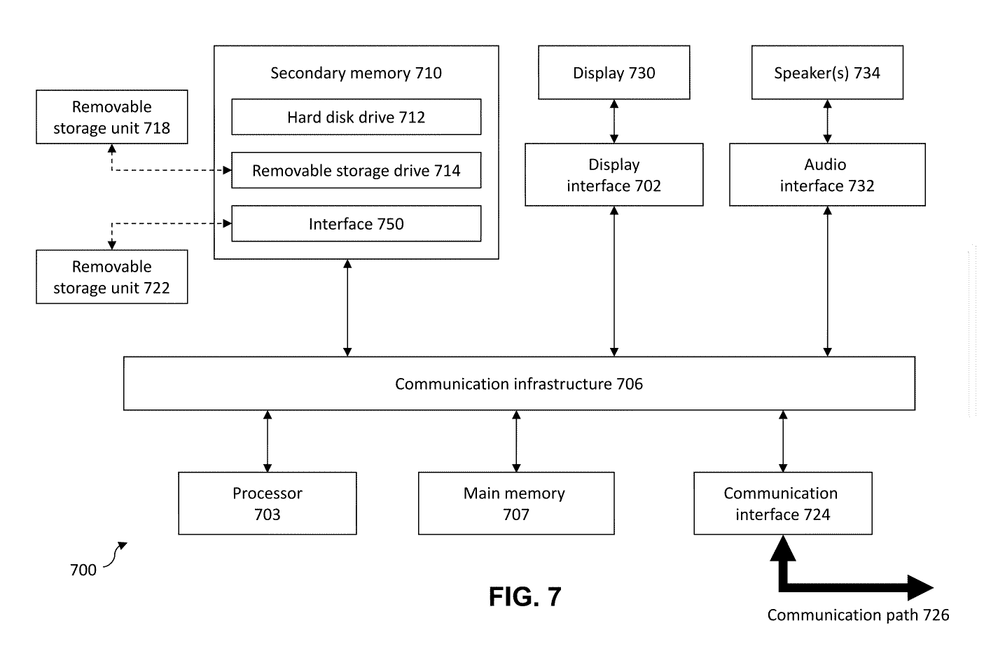

FIG. 7 shows an exemplary computing device 700, to realize a server executing the method steps as shown in FIG. 2. The following description of the computing device 700 is provided by way of example only and is not intended to be limiting. Therefore, one or more elements or components of the computing device 700 may be omitted. Also, one or more elements or components of the computing device 700 may be combined together. Additionally, one or more elements or components of the computing device 700 may be split into one or more component parts.

With reference to FIG. 7, the exemplary computing device 700 includes a processor 703 for executing software routines. Although a single processor is shown for the sake of clarity, the computing device 700 may also include a multi-processor system. The processor 703 is connected to a communication infrastructure 706 for communication with other components of the computing device 700. The communication infrastructure 706 may include, for example, a communications bus, cross-bar, or network.

The computing device 700 further includes a main memory 707, such as a random access memory (RAM), and a secondary memory 710. The secondary memory 710 may include, for example, a hard disk drive 712 and/or a removable storage drive 714, which may include a floppy disk drive, a magnetic tape drive, an optical disk drive, or the like. The removable storage drive 714 reads from and/or writes to a removable storage unit 718 in a well-known manner. The removable storage unit 718 may include a floppy disk, magnetic tape, optical disk, or the like, which is read by and written to by removable storage drive 714. As will be appreciated by persons skilled in the relevant art(s), the removable storage unit 718 includes a computer readable storage medium having stored therein computer executable program code instructions and/or data.

In an alternative implementation, the secondary memory 710 may additionally or alternatively include other similar means for allowing computer programs or other instructions to be loaded into the computing device 700. Such means can include, for example, a removable storage unit 722 and an interface 750. Examples of a removable storage unit 722 and interface 750 include a program cartridge and cartridge interface (such as that found in video game console devices), a removable memory chip (such as an EPROM or PROM) and associated socket, and other removable storage units 722 and interfaces 750 which allow software and data to be transferred from the removable storage unit 722 to the computing device 700.

The computing device 700 also includes at least one communication interface 724. The communication interface 724 allows software and data to be transferred between computing device 700 and external devices via a communication path 726. In various implementations, the communication interface 724 permits data to be transferred between the computing device 700 and a data communication network, such as a public data or private data communication network. The communication interface 724 may be used to exchange data between different computing devices 700 which such computing devices 700 form part an interconnected computer network. Examples of a communication interface 724 can include a modem, a network interface (such as an Ethernet card), a communication port, an antenna with associated circuitry and the like. The communication interface 724 may be wired or may be wireless. Software and data transferred via the communication interface 724 are in the form of signals which can be electronic, electromagnetic, optical or other signals capable of being received by communication interface 724. These signals are provided to the communication interface via the communication path 726.

As shown in FIG. 7, the computing device 700 further includes a display interface 702 which performs operations for rendering images to an associated display 730 and an audio interface 732 for performing operations for playing audio content via associated speaker(s) 734.

As used herein, the term “computer program product” may refer, in part, to removable storage unit 718, removable storage unit 722, a hard disk installed in hard disk drive 712, or a carrier wave carrying software over communication path 726 (wireless link or cable) to communication interface 724. A computer readable medium can include magnetic media, optical media, or other recordable media, or media that transmits a carrier wave or other signal. These computer program products are devices for providing software to the computing device 700. Computer readable storage medium refers to any non-transitory tangible storage medium that provides recorded instructions and/or data to the computing device 700 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computing device 700. Examples of transitory or non-tangible computer readable transmission media that may also participate in the provision of software, application programs, instructions and/or data to the computing device 700 include radio or infra-red transmission channels as well as a network connection to another computer or networked device, and the Internet or Intranets including e-mail transmissions and information recorded on Websites and the like.

The computer programs (also called computer program code) are stored in main memory 707 and/or secondary memory 710. Computer programs can also be received via the communication interface 724. Such computer programs, when executed, enable the computing device 700 to perform one or more steps of validation of a card design as described above with reference to FIG. 2. The computer programs, when executed, enable the processor 703 to validate a card design. Accordingly, such computer programs may represent controllers of the computing device 700.

Software may be stored in a computer program product and loaded into the computing device 700 using the removable storage drive 714, the hard disk drive 712, or the interface 750. Alternatively, the computer program product may be downloaded to the computing device 700 over the communications path 726. The software, when executed by the processor 703, causes the computing device 700 to perform the necessary operations to execute the method steps as shown in FIGS. 2 and 3. For example, in FIG. 3, a processor 359 is responsible for performing the steps 325, 345, 365 and 385, the processor 359 being in communication with the design requirement database 355.

The processor 703 may execute computer program code that is stored in one or more of the hard disk drive 712, memory 707, secondary memory 710, removable storage drive 714, removable storage unit 718 and removable storage unit 722 that allows the computing device 700 to perform the method shown in FIG. 2. Accordingly, the computing device 700 provides for a computer system for computer-aided validation of a card design, the computer system comprising at least one processor 703, and at least one memory 712, 707, 710, 714, 718 and 722 including computer program code. the at least one memory 712, 707, 710, 714, 718 and 722 and the computer program code configured to, with the at least one processor 703, cause the computer system at least to: detect a plurality of design elements related to a card design via an image recognition device and encode the design elements into data elements; compare the data elements against design requirement encoded as design requirement data; validate the card design by determining if each of the data elements are compliant with the design requirement; wherein the comparison of the data elements and the validation of the card design is performed at a processor; and provide a result of the validation via a user interface.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

What is claimed is:

1. A method for computer-aided validation of a card design, the method comprising the steps of:
detecting a plurality of design elements related to a card design via an image recognition device and encoding the design elements into data elements;
comparing the data elements against design requirement encoded as design requirement data;
validating the card design by determining if each of the data elements are compliant with the design requirement;
wherein the comparison of the data elements and the validation of the card design is performed at a processor; and
providing a result of the validation via a user interface.

2. The method in accordance with claim 1, wherein the result of the validation, provided via the user interface, is an indication of a degree of compliance that the data element has with the design requirement.

3. The method in accordance with claim 2, wherein the indication, provided via the user interface, comprises a message providing details of the degree of compliance and acceptability to the design requirement; and/or
wherein the indication, provided via the user interface, comprises a graphical element directing attention to a compliant or non-compliant design element.

4. The method in accordance with claim 1, further comprising recognising at least one of the data elements that are proprietary to the card design; and
determining whether the at least one of the data elements are in compliance with the design requirement of the proprietary design element.

5. The method in accordance with claim 1, wherein the design requirement comprises any one or more of the card dimensions including length, width, thickness, and radius of corners of the card;
wherein the design requirement comprises any one or more of text and number requirements including typeface, colour, size, height, contrast, italicisation, spacing, abbreviation, presentation format, and content;
wherein the design requirement comprises any one or more of graphical object requirements including orientation, positioning, aspect ratio, dimension, opacity, sharpness, presence, and relative distances;
wherein the design requirement comprises any one or more of colour parameter requirements including value, hue, and chroma; and/or
wherein the design requirement comprises a layout that is compliant to any one or more standards including International Organization for Standardization (ISO)/International Electrotechnical Commission (IEC) 7810, ISO/IEC 7811, ISO/IEC 7816, and/or card design guidelines.

6. The method in accordance with claim 1, wherein the step of detecting the plurality of design elements is performed using an automated image recognition technique.

7. The method in accordance with claim 1, wherein the step of validating the card design is performed using a rule based validation technique.

8. The method in accordance with claim 1, wherein the step of validating the card design comprises the step of:
configuring the processor to retrieve the set of design requirement data related to the card design from a database; and
comparing the data elements with the retrieved set of design requirement data at the processor.

9. The method in accordance with claim 1, wherein the result, provided via the user interface, comprises a score calculated from the number of data elements that are compliant with the design requirements.

10. The method in accordance with claim 1, wherein the result, provided via the user interface, comprises one or more suggestions to adjust the design elements to comply with the design requirements.

11. The method in accordance with claim 10, wherein the adjustment of the design elements is performed automatically.

12. The method in accordance with claim 1, wherein the card design is for a physical or an electronic design.

13. A computer system for computer-aided validation of a card design, the computer system comprising an image recognition device, a user interface, at least one processor, and at least one memory including computer program code, the at least one memory and the computer program code configured to, with the at least one processor, cause the computer system at least to:
detect a plurality of design elements related to a card design via the image recognition device and encode the design elements into data elements;
compare the data elements against design requirement encoded as design requirement data;
validate the card design by determining if each of the data elements are compliant with the design requirement;
wherein the comparison of the data elements and the validation of the card design is performed at the at least one processor; and
provide a result of the validation via the user interface.

14. The computer system of claim 13, wherein the result of the validation, provided via the user interface, is an indication of a degree of compliance that a data element has with the design requirement.

15. The computer system of claim 14, wherein the indication, provided via the user interface, comprises a message providing details of the degree of compliance and acceptability to the design requirement; and/or
wherein the indication, provided via the user interface, comprises a graphical element directing attention to a compliant or non-compliant design element.

16. The computer system of claim 13, wherein the detection of the plurality of design elements is performed using an automated image recognition technique.

17. The computer system of claim 13, wherein the validation of the card design is performed using a rule based validation technique.

18. The computer system of claim 13, wherein the at least one memory and the computer program code configured to, with the at least one processor, cause the computer system, when validating the card design, at least to:
retrieve the set of design requirement data related to the card design from a database; and
compare the data elements with the retrieved set of design requirement data at the at least one processor.

19. The computer system of claim 13, wherein the result, provided via the user interface, comprises one or more suggestions to adjust the data elements to comply with the design requirements.

20. The computer system of claim 19, wherein the adjustment of the design elements is performed automatically.

21. A non-transitory computer readable medium comprising computer executable instructions which when executed by a computer cause the computer to perform the method of:
detecting a plurality of design elements related to a card design via an image recognition device and encode the design elements into data elements;
comparing the data elements against design requirement encoded as design requirement data;
validating the card design by determining if each of the data elements are compliant with the design requirement;
wherein the comparison of the data elements and the validation of the card design is performed at a processor; and
providing a result of the validation via a user interface.
